(19) United States
(12) Patent Application Publication
(10) Pub. No.: US 2021/0086662 A1
(43) Pub. Date: Mar. 25, 2021

(54) METHOD FOR OPERATING AN INTERIOR OF A MOTOR VEHICLE

(71) Applicant: Brose Fahrzeugteile SE & Co. Kommanditgesellschaft, Bamberg, Bamberg (DE)

(72) Inventors: Matthias GEMPEL, Bamberg (DE); Florian POHL, Ebersdorf (DE); Thomas WEINGÄRTNER, Lichteneiche (DE); Manfred STENZEL, Bamberg (DE)

(73) Assignee: Brose Fahrzeugteile SE & Co. Kommanditgesellschaft, Bamberg, Bamberg (DE)

(21) Appl. No.: 16/981,457

(22) PCT Filed: Mar. 14, 2019
(86) PCT No.: PCT/EP2019/056370

§ 371 Date: Sep. 16, 2020

(30) Foreign Application Priority Data
Mar. 16, 2018 (DE) 10 2018 204 053.2

(51) Int. Cl. B60N 2/02; B60N 2/00; B62D 1/181; B60R 16/00

(52) U.S. Cl. CPC B60N 2/0252; B60N 2/002; B60N 2/0232; G01S 17/894; B60R 16/005; B60N 2002/0272; B62D 1/181

(57) ABSTRACT

A method for operating an interior of a motor vehicle, having a number of electro-motive adjusting drives which each have an adjusting part, to which an adjusting path is assigned. The position of the adjusting parts is detected by means of a 3D sensor which is spaced apart from the electromotive adjusting drives. Said method further relates to an interior of a motor vehicle.

### CROSS-REFERENCE TO RELATED APPLICATIONS

This application is the U.S. National Phase of PCT Application No. PCT/EP2019/056370 filed on Sep. 19, 2019, which claims priority to German Patent Application No. DE 10 2018 204 053.2, filed on Mar. 16, 2018, the disclosures of which are hereby incorporated in their entirety by reference herein.

### TECHNICAL FIELD

The present disclosure relates to a method of operating an interior of a motor vehicle.

### BACKGROUND

Interiors of motor vehicles usually have a number of adjusting drives by means of which an adjustable part can be moved along a specific adjustment path in each case. The adjustable part is, for example, a seat or a part of a seat, such as a backrest or a headrest. Therefore, the seat is adapted to the respective user by means of the adjusting drive, so that the comfort level is increased. The adjusting drive is manual for example, and a gear mechanism which is operatively connected to the respective adjustable part is operated by means of a rotary wheel or the like for example.

In order to further increase the comfort level, electromotive adjustment of the adjustable parts takes place to an increasing extent. In other words, the adjusting drives are configured as electromotive adjusting drives. The respective electric motor is usually operated depending on a user input, and a continuous user input or only a single user input is used for example. As soon as an end of the adjustment path, for example a stop or the like, is reached by means of the adjustable part, it is necessary to stop the electric motor since otherwise overloading of the electric motor occurs. This can lead to excessive heating of the electric motor and consequently to destruction of said electric motor. Excessive mechanical stressing of further constituent parts of the electromotive adjusting drive is also possible in this case.

### SUMMARY

One or more objects of the present disclosure may be to provide a method of operating an interior of a motor vehicle while reducing production costs are reduced and/or increasing safety.

According to one or more embodiments, a method of operating an interior of a motor vehicle, is provided. The interior may be suitable for accommodating a number of people (occupants). To this end, the interior has, in particular, a number of seating facilities. The interior itself is, for example, closed or has a number of closable openings, in particular doors, by way of which people can enter. For example, the roof lining is rigid or it is possible to at least partially remove the roof lining. In other words, the motor vehicle is a cabriolet in this case. The interior has a number of electromotive adjusting drives which each have an adjustable part. In this case, the adjustable part is driven by an electric motor which is allocated to the respective electromotive adjusting drive. The electric motor is, for example, a commutator motor with brushes. As an alternative to this, the electric motor is configured without brushes. For example, the electric motor is a brushless DC motor (BLDC). In particular, the electric motor is a synchronous motor. As an alternative, the electric motor is an asynchronous motor. In particular, the electric motors of at least some of the electromotive adjusting drives are structurally identical to one another or the electric motors differ. In particular, the interior has two, three or more electromotive adjusting drives of this kind.

For example, the interior has a seat which may include at least one electromotive adjusting drive, for example a plurality of electromotive adjusting drives. The electromotive adjusting drives of the seat differ for example. The adjustable parts are, for example, the headrest, a backrest or a sitting surface of the seat. The motor vehicle suitably has at least one further seat of this kind, and the corresponding electromotive adjusting drives of the two seats are structurally identical to one another. At least one of the electromotive adjusting drives, such all of the electromotive adjusting drives, may have a gear mechanism which is driven by means of a respectively associated electric motor. The gear mechanism itself is operatively connected to the adjustable part. The gear mechanism is, for example, a worm gear mechanism, a spindle or may include at least one of these. Each adjustable part can be adjusted along an adjustment path. In other words, an adjustment path is allocated to the adjustable part. In this case, a single adjustable part is associated with a plurality of electromotive adjusting drives, and the adjustment paths between the different electromotive adjusting drives differ. Therefore, in particular, an adjustable part with two of the electromotive adjusting drives can be adjusted along two different adjustment paths which are perpendicular to one another for example. For example, a sitting surface of the seat can be moved in a translatory manner, in particular along the longitudinal axis of the motor vehicle, and in a rotational manner. Therefore, when the adjustable part is displaced in a translatory direction, the adjustment path about the rotation axis changes since the rotation axis is likewise displaced in a translatory direction.

The interior further has a 3D sensor which is spaced apart from the electromotive adjusting drives. The 3D sensor has, for example, only one single sensor unit which is positioned at a single point within the interior. For example, the 3D sensor has a plurality of sensor units which are spaced apart from one another. It is possible to determine a position of a part in space during operation by means of the 3D sensor. The method makes provision for the position of the adjustable parts to be detected by means of the 3D sensor. As an example, a configuration of the interior of the motor vehicle can be derived from this. In other words, the position of the adjustable parts can be directly detected by means of the 3D sensor. As an example, the position of the adjustable parts is detected in a contactless manner.

Safety is increased on account of the direct detection since, in the event of constituent parts of one of the electromotive adjusting drives failing or breaking, the malfunction can be directly identified and the position of the adjustable part is not further incorrectly determined on the basis of a theoretical model. It is also not necessary for each electromotive adjusting drive to have a unit for determining the position of the respectively associated adjustable part, this reducing production costs. Therefore, installation space, cabling complexity and weight of the electromotive adjusting drives and therefore of the entire motor vehicle is also provided.

As an example, the ascertained positions are used for adjusting at least one of the adjustable parts in a controlled manner. In this case, the position of the adjustable parts is expediently repeatedly ascertained, for example even independently of an adjustment which has been carried out.

For example, the position of the adjustable parts relative to the 3D sensor is ascertained by means of the 3D sensor. In other words, the 3D sensor is used as a reference system for ascertaining the position of the adjustable parts. As an alternative to this, a specific position in the interior of the motor vehicle is determined and the position of the adjustable parts in relation to this position is determined. For example, the position of all of the adjustable parts with respect to this fixed point is determined and further actuation of the electromotive adjusting drives is derived from this. As an alternative to this, a plurality of fixed points of this kind are associated with the interior, and the electromotive adjusting drives are split into subgroups, and one of the fixed points is allocated to each of the subgroups. For example, in each case one of the fixed points is allocated to each seat of the interior, so that the position of the rests or sitting surfaces is always determined with respect to the fixed point, which is respectively associated with the same seat, by means of the 3D sensor. Therefore, the configuration of each seat is separately determined. In this case, the position of the adjustable parts of the respective seat is initially detected by means of the 3D sensor and the position with respect to the fixed point which is associated with the same seat is then determined. This is used, for example, as a configuration of the seat. The fixed point or the fixed points is/are, for example, constant or variable during operation, suitably depending on environmental variables and/or a user setting.

A fixed adjustable part may be allocated to each adjustable part. In this case, the length of the adjustment path is constant in particular. However, at least one of the adjustment paths may be set depending on the position of at least two of the adjustable parts. In this case, the position of the adjustable part with which the adjustment path is associated is used in particular. The position of a further one of the adjustable parts may be additionally used to determine precisely this adjustment path. The adjustment path may be shortened when the further adjustable part is in the adjustment path. This prevents the adjustable part from being moved toward the further adjustable part. For example, the anatomy of occupants of the interior is also taken into account, so that injury to said occupants is prevented.

The 3D sensor may be additionally suitable, provided and designed, to identify an obstacle. The obstacle is, for example, a person, an occupant in the interior. As an alternative to this, the obstacle is an object which is located in the interior and the position of said object is, for example, varied or is prespecified by a user of the motor vehicle. The obstacle is, for example, an item of luggage or the like. In this case, the obstacle is identified by means of the 3D sensor, and at least one of the adjustment paths may be set depending on the position of the obstacle. In this case, movement of one of the adjustable parts, such as all of the adjustable parts, toward the obstacle is prevented. For example, all of the adjustment paths are set in such a way that the obstacle is free of the adjustment paths. In other words, no adjustment path passes through the obstacle. In this case, the adjustment paths are expediently accordingly shortened. If an adjustable part can be adjusted not only along a single predetermined adjustment path, but rather a target position over a plurality of different adjustment paths can be achieved for example, the adjustment path is expediently selected and therefore set depending on the position of the obstacle. In other words, when an obstacle is identified, the adjustable part is expediently adjusted in such a way that the obstacle is bypassed with a bypassing evasive movement.

As an alternative, at least one of the adjustment paths is set in such a way that a movement toward the obstacle is rendered possible but damage to the obstacle is prevented. If the obstacle is a person, movement of the adjustable part toward the person is rendered possible for example, movement of a backrest of a seat toward the occupant. However, in this case, the adjustment path is expediently shortened, so that injury to the person is substantially precluded. For example, when the adjustable part moves toward the obstacle if said obstacle is moving for example, the adjustable part is stopped and/or the associated electric motor is reversed, so that the obstacle is released if said obstacle is trapped by means of the adjustable part for example.

The interior is a constituent part of a motor vehicle and has a number of electromotive adjusting drives. Each electromotive adjusting drive has an adjustable part which is driven by a respectively associated electric motor. In this case, an adjustable part is associated with a plurality of the electromotive adjusting drives for example. An adjustment path along which the respective adjustable part can be adjusted by means of the electric motor is allocated to each electromotive adjusting drive. For this purpose, the respective adjustable part is driven by the electric motor which is associated with the respective electromotive adjusting drive, via a gear mechanism which may include a worm gear mechanism and/or a spindle for example. The electric motor is, for example, a commutator motor with brushes or a brushless electric motor, a brushless DC motor. For example, the electric motor is a synchronous motor or an asynchronous motor. The interior further has a 3D sensor which is spaced apart from the electromotive adjusting drives. As an example, the 3D sensor is spaced apart from all of the adjustable parts and/or associated electric motors and consequently is at a distance of expediently greater than 10 cm, 20 cm or 30 cm.

Furthermore, the interior has a control unit for carrying out a method in which the position of the adjustable parts is determined by means of the 3D sensor. The control unit is suitable, provided and designed, for this purpose. As a result, the position of the individual adjustable parts can be directly determined, and these positions are not derived on the basis of secondary data, this increasing safety, if a malfunction in at least one constituent part of one of the electromotive adjusting drives occurs. In addition, it is not necessary to store the positions of the adjustable parts, and therefore a memory can be dispensed with. Furthermore, the position of the adjustable parts can always be re-detected if there is a power cut and the memory is deleted. In addition, it is not necessary to calibrate the electromotive adjusting drives since the position of the individual adjustable parts can always be directly detected by means of the 3D sensor.

At least one of the electromotive adjusting drives or all of the electromotive adjusting drives, does/do not have position sensors. In other words, the electromotive adjusting drives themselves do not have a position sensor. As an example, the respective electric motor is free of a rotation speed sensor, that is to say does not have a rotation speed sensor. As a result, the position of the adjustable parts can be determined only by means of the 3D sensor. As a result, it is possible to configure the electromotive adjusting drives with electric motors of comparatively small construction, this reducing installation space. In addition, production costs are reduced.

The interior may include an electromotively adjustable seat which has at least one of the electromotive adjusting drives. The seat is, for example, a driver's seat or a passenger seat. As an alternative to this, the seat is a constituent part of a further row of seats in the interior or a rear bench. At least two of the seats in the interior can suitably be adjusted by electric motor and therefore each have at least one of the electromotive adjusting drives. As an example, the adjustable part is a headrest, a backrest and/or a sitting surface of the respective seat. As an alternative to this, the adjustable part is an armrest. For example, at least one of the electromotive adjusting drives is allocated to each constituent part of the seat. As an alternative to this, a plurality of the electromotive adjusting drives, for example two of the electromotive adjusting drives, are allocated to at least one of the constituent parts of the seat. Setting of a translatory position and also inclination is suitably rendered possible by means of the respectively associated electromotive adjusting drives. Therefore, one of the adjustment paths is, for example, along the longitudinal axis of the motor vehicle, and the further adjustment path is about a pivot axis which is transverse to the longitudinal axis in the horizontal direction. In other words, an inclination, for example, of the sitting surface, the backrest, the headrest and/or the armrest can be set by the respectively associated electromotive adjusting drive. As a result, the comfort level for the occupant is further increased.

As an alternative, the interior may include an electromotively adjustable center console which has at least one of the electromotive adjusting drives. In this case, a covering of the center console is electromotively adjusted by means of the associated electromotive adjusting drive, so that a compartment is opened for example. Therefore, the cover is the adjustable part. As an alternative to or in combination with this, a height of the electromotively adjustable center console is changed, so that said center console can serve as an armrest for the occupant.

For example, the interior has an electromotively adjustable steering wheel which has at least one electromotive adjusting drive. As an example, the position of a steering wheel rim along a direction which is prespecified by means of a steering column can be set by means of the electromotive adjusting drive. Therefore, the steering wheel rim and/or a part of the steering column at least partially form/forms the adjustable part. Therefore, it is possible to move the steering wheel rim toward the user by electric motor. The adjustment path is suitably set depending on the position of the electromotively adjustable seat which may be present. Therefore, excessive movement of the steering wheel rim toward the seat and as a result toward the occupant is prevented, if the seat is located in a position which is comparatively far forward. In addition, the height of the steering wheel rim can be set for example, and the steering column and the steering wheel rim can be suitably pivoted about a pivot axis, which runs transversely to the longitudinal axis and horizontally, by means of a further electromotive adjusting drive.

The 3D sensor is, a propagation time-based sensor. In other words, the position of the individual adjustable parts is ascertained on the basis of evaluating a propagation time. In other words, the 3D sensor is a TOF (“Time Of Flight”) sensor. The 3D sensor may emit waves which are scattered and/or reflected at the adjustable parts. The reflected and/or scattered waves are detected by means of the 3D sensor and the position of the individual adjustable parts is ascertained from this process. Therefore, the position of the individual adjustable parts can be detected in a comparatively reliable manner. Therefore, a propagation time measurement may be used for determining the position. As an alternative or in combination, the position is determined on the basis of evaluation of a phase shift/a phase offset of the emitted waves with respect to the reflected/scattered waves. As an example, the 3D sensor has a plurality of sensor units, and said sensor units are arranged spaced apart from one another for example. In this case, individual sensor units are trained to receive the waves, and one of the sensor units is set, for emitting the waves.

The waves are, for example, electromagnetic waves which are in the visible range for example. In other words, the 3D sensor is a camera or may include at least one camera. The 3D sensor may be a TOF camera or may include at least one TOF camera. In one alternative, the electromagnetic waves are in the infrared range, and therefore operation of the 3D sensor is not noticed by a user. As an alternative to this, the frequency of the electromagnetic waves is in the radiofrequency range, and the 3D sensor is a radar sensor. For example, the electromagnetic waves are emitted by means of the 3D sensor or merely received, if the electromagnetic waves are detected in the visible range. In this case, the 3D sensor is designed, for example, as a stereo camera. As an alternative to this, laser light is emitted by means of the 3D sensor, and the 3D sensor is a laser scanner. As an alternative, the 3D sensor is designed for detecting structured light. As an alternative, the waves are sound waves, and the 3D sensor is therefore based on an ultrasound or sonar principle.

For example, the 3D sensor is fastened to a seat of the interior or to a dashboard. However, the 3D sensor may be fastened to an interior mirror. In other words, the interior space has the interior mirror to which the 3D sensor is attached. As a result, the 3D sensor can be integrated into pre-existing constituent parts, and therefore a visually pleasing interior is formed. The position of the 3D sensor is also elevated, and therefore substantially the entire interior can be detected by means of the 3D sensor. Therefore, a comparatively large number of electromotive adjusting drives can also be used. As an alternative to or in combination with this, the 3D sensor is fastened to a roof lining of the interior. In this case, the 3D sensor is located, for example, in a front region, that is to say shifted in the direction of the windscreen, or in a rear region, that is to say shifted in the direction of a luggage compartment or the like. The field of view of the 3D sensor is suitably comparatively large, and therefore substantially the entire interior of the motor vehicle can be monitored by means of a single 3D sensor. As an alternative to this, a plurality of 3D sensors is provided which are fastened, for example, to the roof lining and/or to the interior mirror. As a result, the interior can be monitored in a comparatively reliable manner and therefore the position of individual adjustable parts can be determined in a comparatively reliable manner. In one alternative, the 3D sensor is integrated in a dashboard.

The developments and advantages discussed in connection with the method can analogously be applied to the interior too, and vice versa.

### BRIEF DESCRIPTION OF THE DRAWINGS

An exemplary embodiment of the invention will be explained in more detail below with reference to a drawing, in which:

FIG. 1 schematically shows an interior of a motor vehicle, comprising a number of electromotive adjusting drives, and

FIG. 2 shows a method for operating the interior.

Parts which correspond to one another are provided with the same reference signs throughout the figures.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In order to reliably detect the position of the adjustable part, two Hall sensors are usually used, which Hall sensors are fastened to each electric motor and by means of which Hall sensors the rotation speed and the rotation direction of the respective electric motor are detected during operation. In this case, the position of the adjustable part is determined by means of adding up the individual signals on the basis of a model. However, in the event of comparatively rapid reversal of the direction of the electric motor, it is possible for the signals to be detected incorrectly, so that so-called “miscounting” occurs and the actual position of the adjustable part deviates from the theoretical position by a specific number of Hall signals. Therefore, it is necessary to recalibrate the electromotive adjusting drive after a specific number of adjusting movements.

Furthermore, it is necessary for each electromotive adjusting drive to have at least two sensors of said kind in each case. Therefore, if the interior has a comparatively large number of electromotive adjusting drives, that is to say if the backrest, the sitting surface and the headrest can all be adjusted for example, by several dimensions, the interior has a large number of sensors of said kind, this leading to increased costs and to an increased weight. In addition, installation space and cabling complexity are also increased.

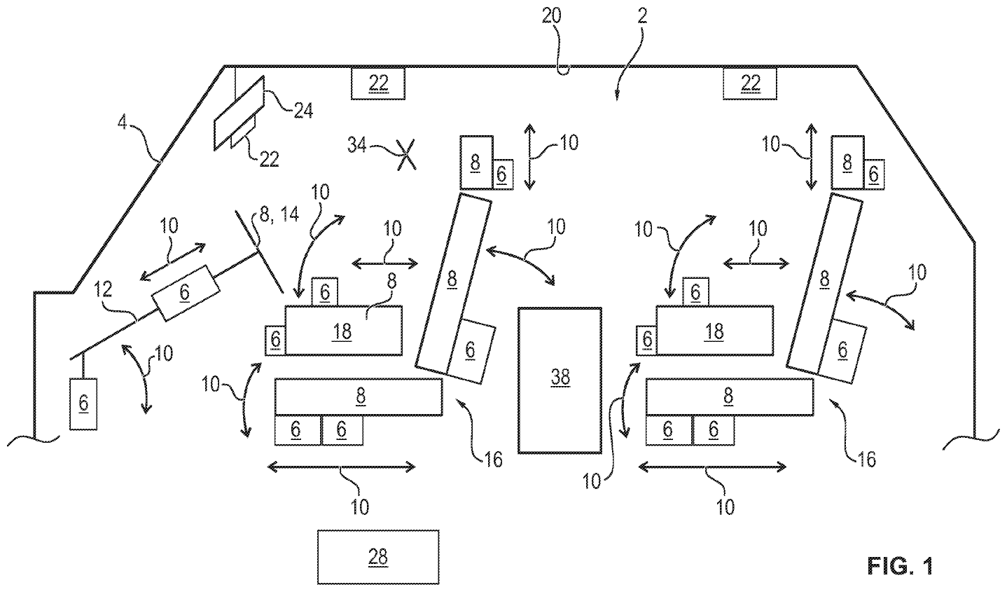

FIG. 1 schematically shows an interior 2 of a motor vehicle 4, which interior may include a number of electromotive adjusting drives 6. The electromotive adjusting drives 6 each have an electric motor, not illustrated in any detail, and a gear mechanism in the form of a worm gear mechanism which can be driven by said electric motor. The electric motors are each configured as brushless DC motors (BLDC) and do not have any rev counters or any Hall sensors either. The further constituent parts of the respective electromotive adjusting drive 6 do not have any sensors of this kind either, and therefore the electromotive adjusting drives 6 are configured without position sensors. An adjustable part 8 which can therefore be moved by electric motor over an adjustment path 10 is driven by the respective electric motor.

The interior 2 further has an electromotively adjustable steering wheel 12 with which two of the electromotive adjusting drives 6 are associated. It is possible to both move a steering wheel rim 14 of the electromotively adjustable steering wheel 12 in a translatory manner and also to pivot said steering wheel rim about an axis which is horizontal and arranged transversely to the vehicle direction by means of said adjusting drives. In other words, one of the adjustment paths 10 which is associated with the steering wheel rim 14 as an adjustable part 8 is in the form of a segment of a circle, and the other adjustment path 10 is rectilinear.

Furthermore, the interior 2 has a total of four electromotively adjustable seats 16 which are arranged to form two rows of seats. In each case one of the electromotively adjustable seats 16 of each row of seats is shown here. Each electromotively adjustable seat 16 has a sitting surface, a backrest and a headrest which each form an adjustable part 8 of an associated electromotive adjusting drive 6. In this case, it is possible to pivot the backrests about a horizontal axis which is arranged transversely to the direction of travel of the motor vehicle 4, and to space apart the headrest from the backrest or to move said headrest toward said backrest. Therefore, both the backrest and also the headrest are each associated with one of the electromotive adjusting drives 6. The sitting surface of each electromotively adjustable seat 16 can be moved in a translatory manner, parallel to the motor vehicle direction (vehicle longitudinal axis) by an associated electric motor as well. Furthermore, an inclination of the sitting surface can be set by means of a further electric motor. In other words, the sitting surface is associated with two of the electromotive adjusting drives 6 as an adjustable part 8, and each electromotively adjustable seat 16 has a total of four electromotive adjusting drives 6.

Furthermore, the interior 2 has two electromotively adjustable center consoles 18 which each comprise two of the electromotive adjusting drives 6. Electromotive displacement parallel to the vehicle longitudinal axis and also setting of an inclination are rendered possible by means of said two electromotive adjusting drives.

In addition, the interior 2 may include a roof lining 20 to which two 3D sensors 22 are attached. In this case, each of the rows of seats, which are formed by means of the four electromotively adjustable seats 16, has associated with it in each case one of the 3D sensors 22 which is arranged substantially above said row of seats. Furthermore, the interior 2 may include an interior mirror 24 to which a 3D sensor 22 is likewise attached. The interior mirror 24 is fastened to the roof lining 20. All of the 3D sensors 22 are propagation time-based sensors and are configured in a structurally identical manner to one another. Furthermore, the 3D sensors 22 are spaced apart from the electromotive adjusting drives 6.

During operation, electromagnetic waves, for example in the infrared or radio wave range, are emitted by means of the 3D sensors 22. Said waves are reflected or scattered at an object, if an object is present. The possibly reflected or scattered waves are detected by means of the same 3D sensor 22 or a further one of the 3D sensors 22. In this case, the distance between the respective 3D sensor 22 and the object at which the waves have been reflected or scattered is determined on the basis of determining the time between emission and reception of the waves and with the aid of the propagation speed of the waves. In a variant which is not illustrated in any detail, at least one of the 3D sensors 22 is dispensed with, or only one of the 3D sensors 22 is present.

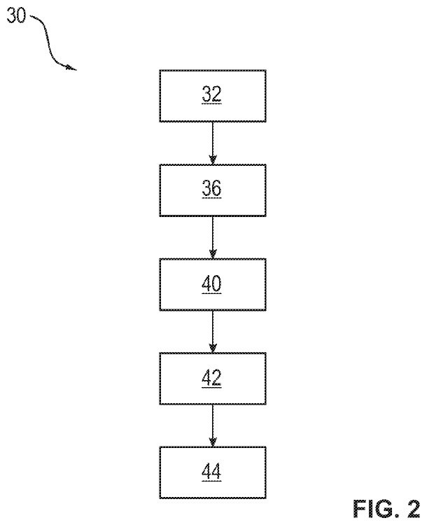

The interior 2 further may include a control unit 28 which is connected in a signal-transmitting manner to all of the electromotive adjusting drives 6 and also the 3D sensors 22. The interior 2 is operated by means of the control unit 28 in accordance with a method 30 illustrated in FIG. 2. In a first working step 32, the position of all of the adjustable parts 8 is detected by means of the 3D sensors 22. For this purpose, electromagnetic waves, sound waves or laser light are/is emitted, for example, by means of the 3D sensors 22, depending on the design. If the 3D sensors 22 are merely passive sensors, an image is created and the position of the adjustable parts 8 is detected on the basis of the image by means of said sensors, in the manner of a camera. In this case, at least one of the 3D sensors 22 has two of the sensor units which are at a comparatively large distance from one another, or two of the 3D sensors 22 are coupled to one another, and therefore the position of the adjustable parts 8 can be determined in a comparatively precise manner on account of a comparatively large spatial angle formed between them.

The position of the adjustable parts 8 is ascertained in relation to a reference point 34 which is arranged, for example, arbitrarily above the electromotively adjustable seat 16 which is configured as a driver's seat. The position of all of the adjustable parts 8 is determined in relation to this reference point 34 which is fixed. In other words, the reference point 34 forms the origin of the coordinate system within which the position of the individual adjustable parts 8 is determined. The position of the adjustable parts 8 is stored as a configuration of the interior 2.

In addition, an obstacle 38 which is located between the two rows of seats for example is identified by means of the 3D sensors 22 in a second working step 36 which takes place substantially at the same time as, before or after the first working step 32. In a subsequent third working step 40, the adjustment paths 10 of the electromotively adjustable seats 16 which are next to the obstacle 38 are limited, and therefore the entire electromotively adjustable seat 16 and the respectively associated backrests 8 cannot be moved toward the obstacle 38, and therefore the obstacle 38 cannot be trapped. In other words, the adjustment paths 10 are limited and therefore set depending on the position of the obstacle 38. On the contrary, the adjustment paths 10 of the electromotively adjustable steering wheel 12 are, for example, not changed on the basis of the position of the obstacle 38 since the obstacle 38 is substantially precluded from being trapped by means of the electromotively adjustable steering wheel 12.

On the contrary, the adjustment paths 10 of the electromotively adjustable steering wheel 12 are limited depending on the electromotively adjustable seat 16 which is designed as a driver's seat, and the current position of the steering wheel rim 14 and also the position of the adjustable parts 8 of said electromotively adjustable seat 16 are already taken into account here. In this case, these adjustment paths 10 are reduced in size and therefore limited, and therefore a minimum distance between the steering wheel rim 14 and the constituent parts of the electromotively adjustable seat 16 is ensured. As a result, a person is prevented from becoming trapped between said electromotively adjustable seat 16 and the steering wheel rim 14. In the event of an accident, it is also ensured, for example, that the steering wheel rim 14 is at a comparatively large distance from the driver, and therefore comparatively severe injuries can be prevented. In other words, the adjustment paths 10 of the electromotively adjustable steering wheel 12 are set depending on the position of at least two of the adjustable parts 8.

In a subsequent fourth working step 42, a user input is detected. In this case, a switch or a number of switches is/are operated by the driver of the motor vehicle 4 for example. On the basis of the switches, it is ascertained that the configuration of the interior 2 should be changed. In an alternative, the fourth working step 42 is carried out before the first and/or second working step 32, 36.

In a subsequent fifth working step 44, the corresponding electromotive adjusting drives 6 are actuated by means of the control unit 28 in order to assume the new configuration and the respective adjustable parts 8 are moved along the respectively associated adjustment path 10. In this case, the movement of the adjustable parts 8 along the adjustment path 10 is monitored by means of the 3D sensors 22, and therefore it is always ensured that the adjustable part 8 is also located in the desired position. In addition, for example, a malfunction of an electromotive adjusting drive 6 can be established in a comparatively simple manner, specifically when the respective adjustable part 8 is not moved even though the associated electric motor has been actuated. In this case, it is possible to stop the respective electromotive adjusting drive 6 and possibly to limit further adjustment paths 10, so that the obstacle 38 is prevented from being trapped for example.

In summary, position/configuration/state monitoring of the individual adjustable parts 8 of the interior 2 of the motor vehicle 4, for example of the backrest, headrest and center console 18, take place by means of one or more of the 3D sensors 22. Said sensors are designed, for example, as “3D Time of Flight” cameras, laser scanners, optical TOF sensors, stereo cameras, cameras with “structured light”, cameras using algorithms, for example “computer vision” or radar sensors. In this way, it is possible to determine the position of the respective adjustable parts 8, that is to say the angle of the backrests, the height of the headrests, the height of the sitting surface, the position of the steering wheel rim, without further sensor systems on the electric motors or other position sensors. In addition, it is possible to approach a desired position in a controlled manner, and the 3D sensors 22 are used to form a control loop. As a result, it is possible to save on sensors on the seats and/or on the adjustable parts 8, this leading to reduced production costs. The detection of the obstacle 38 also prevents the adjustable parts 8 from being moved toward the obstacle 38, so that obstacle identification is provided by means of the 3D sensor or sensors 22.

In other words, a relevant spatial region should be surveyed by means of the 3D sensor 22, which is arranged at a distance from the electromotive adjusting drives 6, and therefore seat adjustment/setting should be rendered possible. The sensor technologies provided for the 3D sensor 22 are sensors by means of which spaces can be surveyed in a three-dimensional manner, and 2-dimensional sensors which are suitably interconnected or the sensor data of which can be correspondingly evaluated by means of a suitable routine, a software routine, are also used here for example. Therefore, the 3D sensor may include a camera for example. The 3D sensor 22 may include an optical “3D Time of Flight” camera. As an alternative, the 3D sensor 22 is configured as a laser scanner or optical TOF sensor, as a stereo camera, as a camera with “structured light”, as a camera using algorithms, for example “computer vision”, or markers or as a radar sensor.

The surveying is performed, for example, by means of one or more of the 3D sensors 22. The respective current position/current configurations of the adjustable parts 8 are ascertained on the basis of the measurement data in an algorithm which has a model of the interior 2, may be of the electromotively adjustable seats 16. Therefore, the seat backrest angle is ascertained, based on the basis of the algorithm with the aid of the model. The 3D sensor 22 therefore serves to adjust/set a function and/or component of the electromotively adjustable seat 16 and also for further functions, such as for all of the functions of the electromotively adjustable seat 16, and all of the seats of the interior 2 are expediently adjusted on the basis of the data of the 3D sensor 22, the adjustment path 10 is set.

The 3D sensor 22 also serves, for adjusting the electromotively adjustable steering wheel 12, for the electromotively adjustable center console 18 and also for electromotively adjustable armrests of the electromotively adjustable seat 16 and also all of the electrically adjustable components of the interior 2. A model is stored in the control unit 28 for all of the adjustable parts 8 and all of the electromotive adjusting drives 6. Therefore, on account of the 3D sensor 22, the individual position sensors for the individual adjustable parts 8 are dispensed with, and the adjustment is controlled in a centralized manner by means of the control unit 28. In this way, collisions between the individual adjustable parts 8 can also be prevented. For example, the adjustable parts 8 are provided with a marker which reflects comparatively strongly in the infrared range as an example. As a result, the position of the adjustable parts 8 can be ascertained in a simplified manner.

As an example, the position of the adjustable parts 8 is determined when there is no occupant located in the interior 2 or when an occupant is located in the interior 2, such as sitting on one of the electromotively adjustable seats 16. For example, the position of the adjustable parts 8 is determined when the user input or another user input is made. As an example, maximum values are associated with each adjustment path 10, and the adjustment paths 10 are limited depending on the position of the further adjustable parts 8 and/or of the obstacle 38 which may be present. On account of the reference point 34, referencing of the position of the adjustable parts 8 to said reference point is possible, so that only a relative measurement can always be carried out.

Installation locations of the 3D sensor 22 may be the roof lining 20, for example in a central position, and a main field of view of the 3D sensor 22 is vertically downward, and therefore at least parts of the front and rear seats and also central components can be detected at the same time. As an alternative, the 3D sensor 22 is arranged in a front region with a viewing direction toward the end of the motor vehicle 4 or in a rear region with a viewing direction in the direction of travel. As an alternative, the 3D sensor is fastened in or on the interior mirror 24.

The function of detecting the position of the adjustable parts 8 is combined, for example, with further functions, such as obstacle identification, and obstacles 38 which are located in the adjustment path 10 of at least one of the adjustable parts 8 are identified. As an alternative or in combination with this, gesture identification of gestures by an occupant of the motor vehicle 4, a reminder function, for example when the driver of the motor vehicle 4 is overtired, and also further monitoring of the driver of the motor vehicle 4 take place.

Once again in other words, adjustment of the adjustable parts 8 is combined with central monitoring by means of the 3D sensor 22 which detects the entire interior 2. As a result, it is possible to detect the obstacles 38, and to accordingly adapt and/or restrict the adjustment. Therefore, it is possible to permit the adjustment only up to specific values or to slow down the adjustment until another object or a further one of the adjustable parts 8 which is moving through the adjustment path 10 has left said adjustment path. It is also possible to move a further adjustable part 8 along a further adjustment path 10, so that a collision is prevented. As a result, it is possible for just one single system to perform all interior adjustment and monitoring, so that further sensor elements, such as an obstacle sensor, can be saved on. A distance which is really measured is determined by means of the 3D sensor 22, this increasing safety. The 3D sensor 22 is, for example, a stereo camera or a TOF camera.

The invention is not restricted to the exemplary embodiment described above. Rather, other variants of the invention can also be derived therefrom by a person skilled in the art, without departing from the subject matter of the invention. All of the individual features described in connection with the exemplary embodiment can furthermore also be combined with one another in a different way, without departing from the subject matter of the invention.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE SIGNS

2 Interior
4 Motor vehicle
6 Electromotive adjusting drive
8 Adjustable part
10 Adjustment path
12 Electromotively adjustable steering wheel
14 Steering wheel rim
16 Electromotively adjustable seat
18 Electromotively adjustable center console
20 Roof lining
22 3D sensor
24 Interior mirror
26 Obstacle
28 Control unit
30 Method
32 First working step
34 Reference point
36 Second working step
38 Obstacle
40 Third working step
42 Fourth working step
44 Fifth working step

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of operating an interior of a motor vehicle including a number of electromotive adjusting drives each including an adjustable part, the method comprising:
detecting by means of a 3D sensor, spaced apart from each of the number of electromotive adjusting drives, a position of one or more of the adjustable parts, and
setting an adjustment path for each of the adjustable parts.

2. The method of claim 1,
wherein at least one of the adjustment paths is allocated based on a position of at least two of the adjustable parts.

3. The method of claim 1,
further comprising:
identifying, by means of the 3D sensor, an obstacle, and wherein the setting step includes setting the adjustment path based on a position of the obstacle.

4. An interior of a motor vehicle comprising:
a number of electromotive adjusting drives disposed in the interior;
a number of adjustable parts each configured to be adjusted by one or more of the number of electromotive adjusting drives;
a 3D sensor spaced apart from each of the number of electromotive adjusting drives and configured to detect a position of an adjustable part of the number of adjustable parts; and
a control unit configured to, responsive to receiving the position of the adjustable part, set an adjustment path for the adjustable part.

5. The interior of claim 4,
wherein each of the number of electromotive adjusting drives do not include a position sensor.

6. The interior of claim 4,
wherein the interior is provided with a seat including
at least one of the number of electromotive adjusting drives and at least one of the number of adjustable parts.

7. The interior of claim 4,
wherein the interior is provided with a
center console including at least one of the number of electromotive adjusting drives and at least one of the number of adjustable parts.

8. The interior of claim 4, wherein one of the adjustable parts of the number of adjustable parts is
an adjustable steering wheel including at least one of the number of electromotive adjusting drives.

9. The interior of claim 4,
wherein the 3D sensor includes a propagation time-based sensor.

10. The interior of claim 4,
wherein the 3D sensor is fastened to a roof lining disposed in the interior or an interior mirror disposed in the interior.

11. The interior of claim 9, wherein the 3D sensor is a time-of-flight (TOF) sensor.

12. A system for use in a vehicle interior, the system comprising:
a first adjustable part configured to move along a first adjustment path having a first travel distance;
an electric adjusting device configured to actuate to move the first adjustable part along the first adjustment path;
a 3D sensor disposed in the vehicle interior and configured to detect a position of the first adjustable part and an obstacle; and
a controller configured to, responsive to receiving the position of the first adjustable part and the obstacle, altering the first adjustment path to a second distance, less than the first distance, to prevent the first adjustable part from colliding with the obstacle.

13. The system of claim 12, wherein the obstacle is a second adjustable part.

14. The system of claim 12, wherein the position of the first adjustable part is based on a distance between the 3D sensor and the first adjustable part.

15. The system of claim 12, wherein the position of the first adjustable part is based on a distance between a fixed point disposed in the interior and the first adjustable part.

16. The system of claim 12, wherein the controller is further configured to, responsive to a malfunction of the electric adjusting device, detect the position of the first adjustable part.

17. The system of claim 12, wherein the controller is further configured to, responsive to a user actuating a switch to adjust the first adjustable part, stop adjustment of the first adjustment part before the first adjustment part reaches the first distance.

18. The system of claim 12, wherein the controller is further configured to, responsive to a user actuating a switch to adjust the first adjustable part, prevent adjustment of the first adjustment part.

19. The system of claim 12, wherein the 3D sensor includes a propagation time-based sensor.

20. The system of claim 12, wherein the first adjustable part is a vehicle seat or a portion of a vehicle seat.
